(19) United States
(12) Patent Application Publication
(10) Pub. No.: US 2024/0097344 A1
(43) Pub. Date: Mar. 21, 2024

(54) REFLECTOR ANTENNA AND ANTENNA APERTURE EXPANSION METHOD

(71) Applicant: NIPPON TELEGRAPH AND TELEPHONE CORPORATION, Tokyo (JP)

(72) Inventors: Koichi HARADA, Musashino-shi, Tokyo (JP); Masaki SHIMA, Musashino-shi, Tokyo (JP); Hiroki SHIBAYAMA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 18/039,560

(22) PCT Filed: Dec. 3, 2020
(86) PCT No.: PCT/JP2020/045112

§ 371 Date: May 31, 2023

(51) Int. Cl. H01Q 15/14; H01Q 19/19

(52) U.S. Cl. CPC H01Q 15/147; H01Q 19/19

(57) ABSTRACT

A reflector antenna includes: a radiator that radiates a radio wave; a main reflector that reflects the radio wave radiated from the radiator in a communication direction; an expansion panel that is attached to at least a part of the main reflector to increase an area of the main reflector; and a first adjustment unit that changes a position of the radiator, or a second adjustment unit that replaces the radiator with a radiator having a different radiation angle. This configuration makes it possible to implement a large-aperture antenna having excellent transportability and operability without preparing another antenna having a large aperture and replacing a standard antenna.

### TECHNICAL FIELD

The present invention relates to a technique for expanding an antenna aperture to increase a gain in a case where the gain is insufficient with the antenna aperture of a standard size.

### BACKGROUND ART

In a satellite communication system using a very small aperture terminal (VSAT) or the like, small earth station devices are used as terminal station devices. The small earth station devices include fixed station devices and portable station devices, and in the case of a portable station device, an antenna of a 0.6 to 0.75 m class is mounted as a standard antenna with emphasis on transportability (see, for example, Non Patent Literature

However, in an area corresponding to an edge of a service area of a communication satellite, it is difficult to maintain communication quality due to an insufficient gain of an antenna. Therefore, an antenna having an aperture larger than the aperture of an antenna mounted as a standard antenna on a portable station device is required. For example, in a satellite network service of a satellite communication company, an antenna aperture corresponding to a position in a service area is recommended, and an antenna having an aperture of 1 m or more is required in a remote island region (see, for example, Non Patent Literature 2).

Note that, even in a case of a planar antenna, it is necessary to expand the antenna aperture, and in the case of the planar antenna, it is necessary to increase the number of antenna elements in order to expand the antenna aperture. However, in this case, a feeder line is long, the transmission loss increases, and thus the radiation efficiency decreases (see, for example, Non Patent Literature 3). Therefore, in terms of transportability and operability, a reflector antenna is more suitable than a planar antenna for expansion of an antenna aperture.

### CITATION LIST

### Non Patent Literature

Non Patent Literature 1: Development of Small Satellite Earth Station Systems (NTT Technical Journal 2012.1)
Non Patent Literature 2: Recommended antenna diameter for ExBird service (introduction page of ExBird of SKY Perfect JSAT), https://www.jsat.net/jp/satellite/common/pdf/antenna-diameter.pdf
Non Patent Literature 3: Institute of Electronics, Information and Communication Engineers “Forest of Knowledge”, Chapter 5, Volume 2, Group 4, Planar Antenna, http://www.ieice-hbkb.org/files/04/04gun_02hen_05.pdf

### SUMMARY OF INVENTION

### Technical Problem

Conventionally, in an edge area of a service area, since the gain of an antenna mounted as a standard antenna (for example, an antenna of 0.75 m) on a portable station device is insufficient, the antenna is changed to an antenna having a larger aperture (for example, an antenna of 1 m) for operation. Therefore, when an antenna is operated in the edge area of the service area, it is necessary to prepare another antenna having a large aperture and replace a standard antenna, which causes a problem in transportability and operability.

An object of the present invention is to provide a reflector antenna and an antenna aperture expansion method capable of implementing a large-aperture antenna having excellent transportability and operability without preparing another antenna having a large aperture and replacing a standard-aperture antenna, by attaching an aperture expansion panel to a main reflector of the standard-aperture reflector antenna and changing one or both of a radiator and a sub-reflector.

### Solution to Problem

The present invention provides a reflector antenna including: a radiator that radiates a radio wave; a main reflector that reflects the radio wave radiated from the radiator in a communication direction; an expansion panel that is attached to at least a part of the main reflector to increase an area of the main reflector; and a first adjustment unit that changes a position of the radiator, or a second adjustment unit that replaces the radiator with a radiator having a different radiation angle.

Furthermore, the reflector antenna further includes: a sub-reflector between the radiator and the main reflector; and a third adjustment unit that replaces the sub-reflector with a sub-reflector having a different reflection angle, or a sub-expansion panel that is attached to at least a part of the sub-reflector to expand the sub-reflector.

The present invention provides an antenna aperture expansion method for a reflector antenna including a radiator that radiates a radio wave and a main reflector that reflects the radio wave radiated from the radiator in a communication direction, the antenna aperture expansion method including: attaching an expansion panel to at least a part of the main reflector to increase an area of the main reflector; and changing a position of the radiator or replacing the radiator with a radiator having a different radiation angle.

Furthermore, in the antenna aperture expansion method, in a case where a sub-reflector is further provided between the radiator and the main reflector, the sub-reflector is replaced with a sub-reflector having a different reflection angle, or a sub-expansion panel is attached to at least a part of the sub-reflector.

### Advantageous Effects of Invention

In a reflector antenna and an antenna aperture expansion method according to the present invention, an aperture expansion panel is attached to a main reflector of a standard-aperture reflector antenna, and one or both of a radiator and a sub-reflector are changed, so that it is possible to implement a large-aperture antenna having excellent transportability and operability without preparing another antenna having a large aperture and replacing the standard-aperture antenna.

### BRIEF DESCRIPTION OF DRAWINGS

FIG. 1 is a diagram illustrating a configuration example of a satellite communication system.

FIG. 2 is a diagram illustrating an example of a parabolic antenna of a standard size mounted on a portable station device.

FIG. 3 is a diagram illustrating an implementation example of a parabolic antenna having an aperture larger than that of the parabolic antenna of FIG. 2.

FIG. 4 is a diagram illustrating an implementation example of a parabolic antenna in a case where the position of a radiator is not changed.

FIG. 5 is a diagram illustrating an example of an offset parabolic antenna of a standard size.

FIG. 6 illustrates an implementation example of an offset parabolic antenna having an aperture larger than that of the offset parabolic antenna of FIG. 5.

FIG. 7 is a diagram illustrating an example of a Cassegrain antenna of a standard size.

FIG. 8 is a diagram illustrating an implementation example of a Cassegrain antenna having an aperture larger than that of the Cassegrain antenna of FIG. 7.

FIG. 9 is a diagram illustrating an example of an offset Cassegrain antenna of a standard size.

FIG. 10 is a diagram illustrating an example of an offset Cassegrain antenna having an aperture larger than that of the offset Cassegrain antenna of FIG. 9.

FIG. 11 is a diagram illustrating an example of a Gregorian antenna of a standard size.

FIG. 12 is a diagram illustrating an implementation example of a Gregorian antenna having an aperture larger than that of the Gregorian antenna of FIG. 11.

FIG. 13 is a diagram illustrating an example of an offset Gregorian antenna of a standard size.

FIG. 14 is a diagram illustrating an implementation example of an offset Gregorian antenna having an aperture larger than that of the offset Gregorian antenna of FIG. 13.

FIG. 15 is a diagram illustrating a specific example of a main reflector of the offset Gregorian antenna.

FIG. 16 is a diagram illustrating an example of a procedure of expanding the main reflector of the offset Gregorian antenna.

FIG. 17 is a diagram illustrating an example of a fixing metal fitting.

### DESCRIPTION OF EMBODIMENTS

Hereinafter, embodiments of a reflector antenna and an antenna aperture expansion method according to the present invention will be described with reference to the drawings.

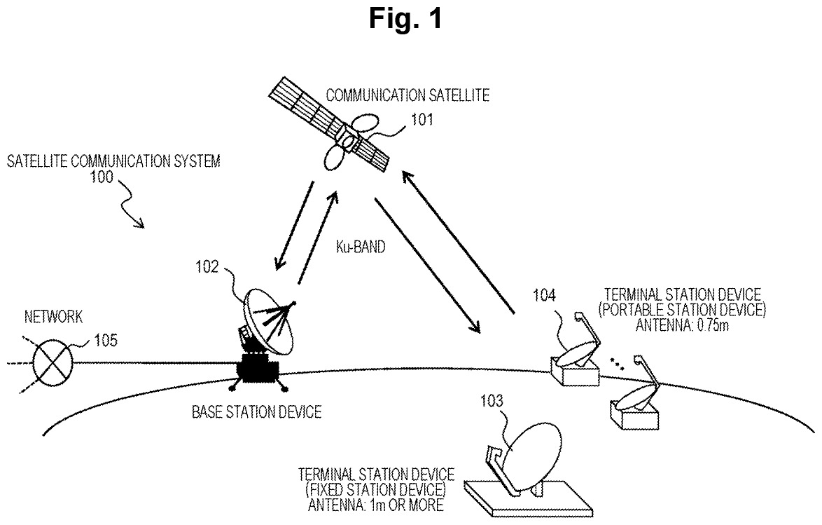

FIG. 1 illustrates a configuration example of a satellite communication system 100. In FIG. 1, the satellite communication system 100 includes a communication satellite 101, a base station device 102, and terminal station devices 103 and 104. The terminal station devices 103 and 104 can communicate with the base station device 102 using radio waves of a Ku-band frequency via the communication satellite 101 and can be connected to a network 105.

Here, the terminal station devices 103 and 104 include a fixed station device and a portable station device. In the example of FIG. 1, the terminal station device 103 is a fixed station device, is mainly used in a place where radio waves are weak, such as near an edge of a service area of the communication satellite 101, and thus includes an antenna having a large aperture of 1 m or more. On the other hand, the terminal station device 104 is a portable station device, and is mainly used in a place where radio waves are strong in the service area of the communication satellite 101, and thus an antenna having a small aperture of about 0.75 m, which has good transportability, is mounted as a standard antenna. Hereinafter, the terminal station device 103 is referred to as the fixed station device 103, and the terminal station device 104 is referred to as the portable station device 104.

Since the portable station device 104 is more excellent in transportability and operability than the fixed station device 103, it is desired to use the portable station device 104 in an area where radio waves are weak. However, when the portable station device 104 is operated in the edge area of the service area, it is necessary to prepare another antenna having a large aperture and replace a standard antenna, and there is a problem in transportability and operability.

In view of this problem, the reflector antenna according to the present embodiment can be used as an antenna having a large aperture by expanding the aperture of a standard size antenna mounted on the portable station device 104 without preparing another antenna having a large aperture and replacing the standard size antenna.

Note that, in each of the following embodiments, an antenna mounted on the portable station device 104 is a reflector antenna. Furthermore, in the embodiments, a parabolic antenna, an offset parabolic antenna, a Cassegrain antenna, an offset Cassegrain antenna, a Gregorian antenna, and an offset Gregorian antenna will be described, but the present invention can be similarly applied to another type of antenna as long as the antenna includes a reflector.

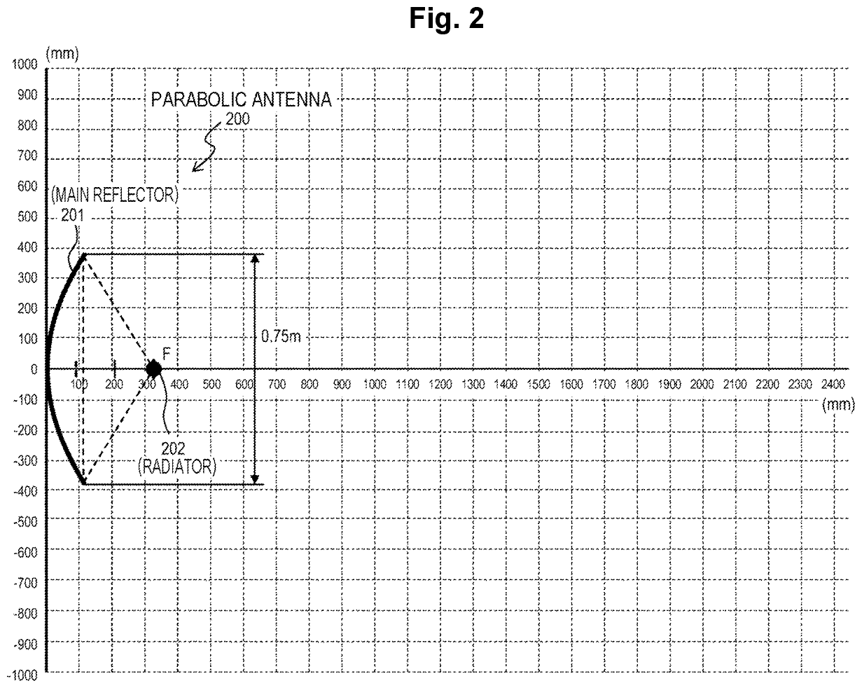

FIG. 2 illustrates an example of a parabolic antenna of a standard size mounted on the portable station device 104. In FIG. 2, the vertical axis represents the antenna aperture direction (mm), and the horizontal axis represents the radio wave radiation direction (mm).

A parabolic antenna 200 illustrated in FIG. 2 includes a main reflector 201 and a radiator 202. The aperture of the main reflector 201 is 0.75 m. The main reflector 201 forms a paraboloid of revolution, and the radiator 202 is arranged at the position of a focal point F of the main reflector 201. The focal point F corresponds to a feeding point, a radio wave is radiated from the radiator 202 to the main reflector 201 at a radiation angle corresponding to the entire surface of the paraboloid of revolution of the main reflector 201, and the radio wave reflected by the main reflector 201 is transmitted in a horizontal direction (communication direction) of the paper surface. Note that, at the time of reception, a radio wave arriving from the horizontal direction (communication direction) is reflected by the main reflector 201 and received by a receiver arranged at the position of the focal point F. The same applies to each of the embodiments described below.

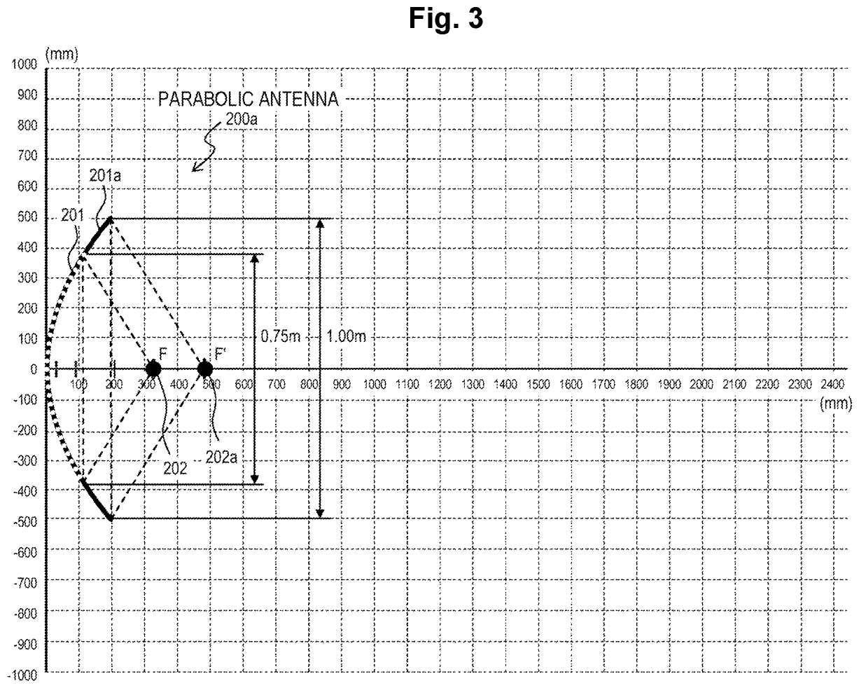

FIG. 3 illustrates an implementation example of a parabolic antenna 200a having an aperture larger than that of the parabolic antenna 200 of FIG. 2. In FIG. 3, the vertical axis represents the antenna aperture direction (mm), and the horizontal axis represents the radio wave radiation direction (mm).

The parabolic antenna 200a can increase the antenna gain by changing the position of the radiator 202 of the parabolic antenna 200 of FIG. 2 and increasing the area of the antenna by expansion of the main reflector 201. Here, since the radiation angle of a radiator 202a of the parabolic antenna 200a is the same as that of the radiator 202 of the parabolic antenna 200, the parabolic antenna 200a does not need to replace the radiator 202, and only needs to include, for example, a slide mechanism (corresponding to a first adjustment unit) that moves the position of the radiator 202 and an expansion panel that expands the main reflector 201, which is described later.

The parabolic antenna 200a illustrated in FIG. 3 includes a main reflector 201a and the radiator 202a. The aperture of the main reflector 201a is 1.00 m. The main reflector 201a forms a paraboloid of revolution, and the radiator 202a is the same as the radiator 202 of FIG. 2 and is arranged at the position of a focal point F′ of the main reflector 201a. The focal point F′ corresponds to a feeding point, a radio wave is radiated from the radiator 202a to the main reflector 201a at the same radiation angle as that of the radiator 202 of FIG. 2, and the radio wave reflected by the main reflector 201a is transmitted in the horizontal direction (communication direction) of the paper surface. Note that, at the time of reception, the operation is reversed.

As described above, the parabolic antenna 200a is implemented by expanding the main reflector 201 and changing the position of the radiator 202 without changing the radiation angle of the radiator 202 of the parabolic antenna 200 mounted as a standard antenna on the portable station device 104, and the antenna gain increases because the area of the main reflector 201a becomes larger than that of the main reflector 201. Note that a portion indicated by a dotted line, which is overlapped with the main reflector 201a, corresponds to the main reflector 201 of FIG. 2, and a portion indicated by a solid line corresponds to the expansion panel attached to the periphery or a part of the main reflector 201, which is described later.

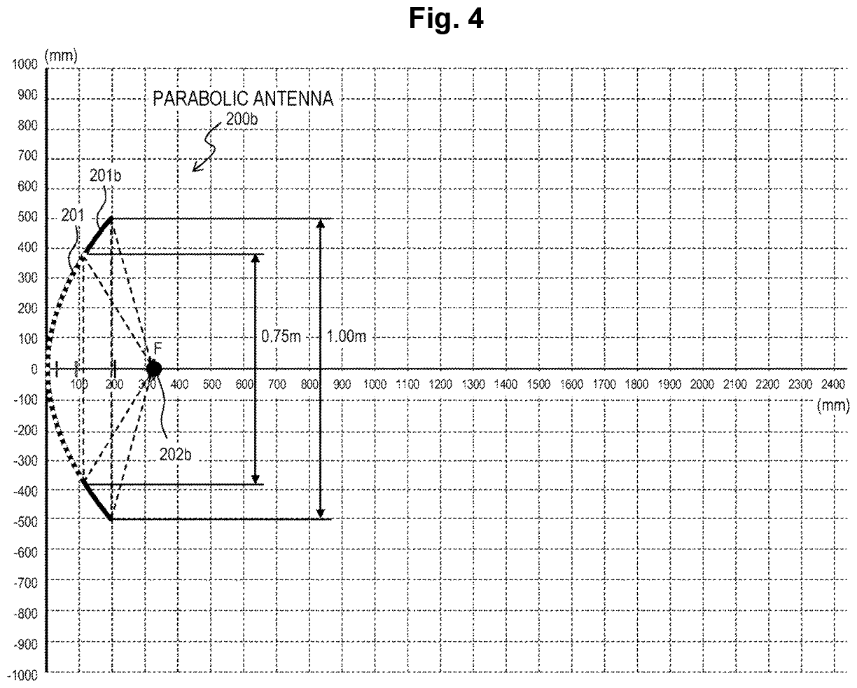

FIG. 4 illustrates an implementation example of a parabolic antenna 200b in a case where the position of the radiator 202 is not changed in FIG. 3. In FIG. 4, the vertical axis represents the antenna aperture direction (mm), and the horizontal axis represents the radio wave radiation direction (mm).

Since the parabolic antenna 200b has a different radiation angle of the radiator 202, it is only necessary to replace the radiator 202 with a radiator 202b and to attach the expansion panel that expands the main reflector 201, which is described later.

Note that the parabolic antenna 200b has, for example, an attaching and detaching mechanism (corresponding to a second adjustment unit) that can easily replace the radiator 202 with the radiator 202b. The attaching and detaching mechanism may be any mechanism used in a general machine. For example, the attaching and detaching mechanism may be a mechanism in which the radiator 202b is slidably inserted, locked at a predetermined position, and unlocked to be removed, or a mechanism in which the radiator 202b is screwed, such as a tripod of a camera.

As described above, the parabolic antenna 200b can increase the antenna gain by changing the radiation angle, which involves the replacement of the radiator 202, and increasing the area of the antenna by expansion of the main reflector 201 without changing the position of the radiator 202 of the parabolic antenna 200 of FIG. 2. Note that a portion indicated by a dotted line, which is overlapped with a main reflector 201b, corresponds to the main reflector 201 of FIG. 2, and a portion indicated by a solid line corresponds to the expansion panel attached to the periphery or a part of the main reflector 201, which is described later.

Here, each of the parabolic antenna 200, the parabolic antenna 200a, and the parabolic antenna 200b described with reference to FIGS. 2, 3, and 4 is a normal center feed type parabolic antenna, the radio wave radiation path is blocked by the radiator 202 and its feed line, and thus radiation characteristics such as side lobe characteristics are deteriorated.

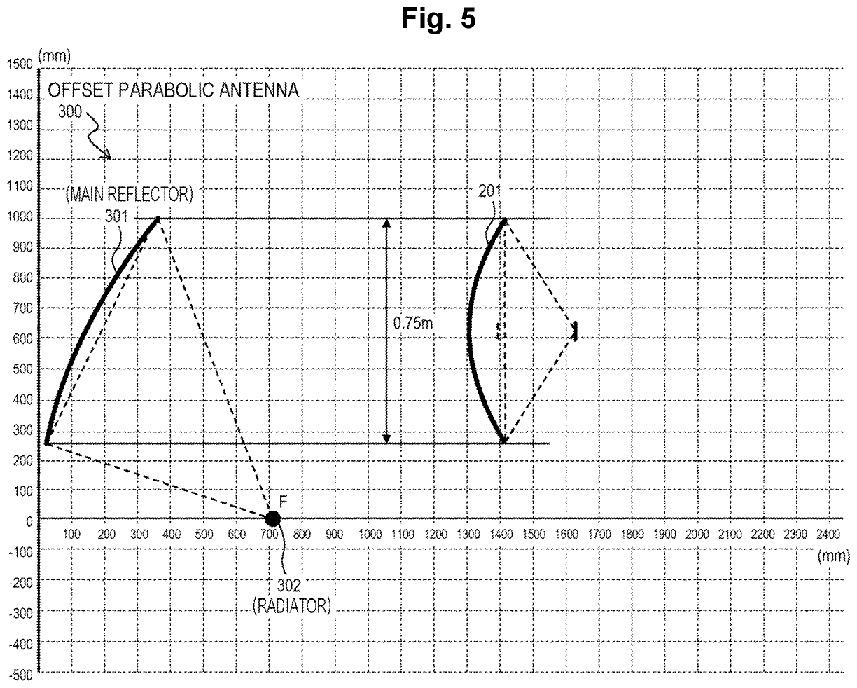

FIG. 5 illustrates an example of an offset parabolic antenna 300 of a standard size. In FIG. 5, the vertical axis represents the antenna aperture direction (mm), and the horizontal axis represents the radio wave radiation direction (mm).

The offset parabolic antenna 300 has the same aperture as the main reflector 201 of the parabolic antenna 200 of FIG. 2, but a radiator 302 is offset from the radio wave radiation path, and thus it is possible to prevent deterioration due to blocking.

The offset parabolic antenna 300 illustrated in FIG. 5 includes a main reflector 301 and the radiator 302. The aperture of the main reflector 301 is the same as that of the main reflector 201 of the parabolic antenna 200, which is 0.75 m. The main reflector 301 forms a paraboloid of revolution, and the radiator 302 is arranged at the position of a focal point F of the main reflector 301. The focal point F corresponds to a feeding point, a radio wave is radiated from the radiator 302 to the main reflector 301 at a radiation angle corresponding to the entire surface of the paraboloid of revolution of the main reflector 301, and the radio wave reflected by the main reflector 301 is transmitted in a horizontal direction (communication direction) of the paper surface. Note that, at the time of reception, the operation is reversed.

In this manner, the main reflector 301 of the offset parabolic antenna 300 functions as a reflector antenna having an aperture of 0.75 m, similarly to the main reflector 201 of the parabolic antenna 200.

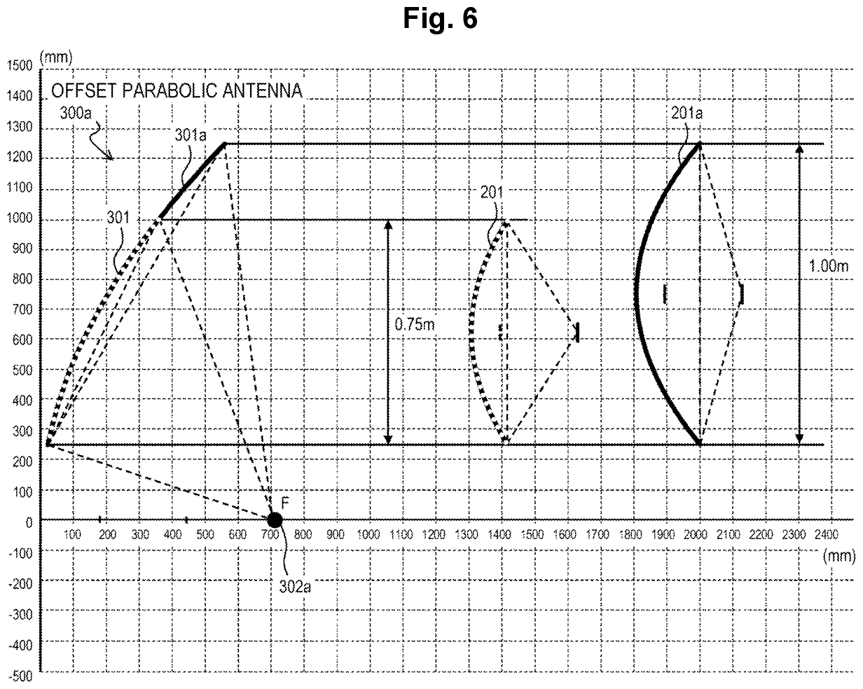

FIG. 6 illustrates an implementation example of an offset parabolic antenna 300a having an aperture larger than that of the offset parabolic antenna 300 of FIG. 5. In FIG. 6, the vertical axis represents the antenna aperture direction (mm), and the horizontal axis represents the radio wave radiation direction (mm).

The offset parabolic antenna 300a can increase the antenna gain by increasing the area of the antenna by expansion of the main reflector 301 and changing the radiation angle, which involves replacement of the radiator 302, without changing the position of the radiator 302 of the offset parabolic antenna 300 of FIG. 5.

The offset parabolic antenna 300a illustrated in FIG. 6 includes a main reflector 301a and a radiator 302a. The aperture of the main reflector 301a is 1.00 m. The main reflector 301a forms a paraboloid of revolution and a focal point F of the main reflector 301a is at the same position as the focal point F of the main reflector 301 of the offset parabolic antenna 300. That is, the radiator 302a is arranged at the same position as the radiator 302 of the offset parabolic antenna 300. The focal point F corresponds to a feeding point, a radio wave is radiated from the radiator 302a to the entire surface of the main reflector 301a at a radiation angle different from that of the radiator 302 of FIG. 5, and the radio wave reflected by the main reflector 301a is transmitted in a horizontal direction (communication direction) of the paper surface. Note that, at the time of reception, the operation is reversed.

Here, a portion indicated by a dotted line, which is overlapped with the main reflector 301a, corresponds to the main reflector 301 of FIG. 5, and a portion indicated by a solid line corresponds to the expansion panel to be described later.

As described above, since the offset parabolic antenna 300a has a larger aperture than the offset parabolic antenna 300 of FIG. 5, the area of the main reflector 301a increases, and the antenna gain increases. Note that, since the radiation angle of the radiator 302a of the offset parabolic antenna 300a is different from that of the radiator 302, it is necessary to replace the radiator 302 with the radiator 302a and to attach the expansion panel to be described later to expand the main reflector 301. That is, in a case where the main reflector 301 is expanded, the offset parabolic antenna 300 can substantially expand the antenna aperture only by replacing the radiator 302.

Note that, in the example of FIG. 6, the main reflector 301 is expanded unidirectionally, but may be expanded bidirectionally or expanded to the entire periphery. In addition, the offset parabolic antenna 300a has, for example, an attaching and detaching mechanism (corresponding to the second adjustment unit) that can easily replace the radiator 302 with the radiator 302b. The attaching and detaching mechanism may be any mechanism used in a general machine, as in the case of the radiator 202b described above.

Here, each of the offset parabolic antenna 300 and the offset parabolic antenna 300a described with reference to FIGS. 5 and 6 is effective as a low side lobe antenna without performance degradation due to blocking of the radiator 302 (radiator 302a) or the like because the radiator 302 (radiator 302a) is offset outside the aperture in the radio wave radiation direction. Furthermore, since the radio wave reflected by the main reflector 301 (main reflector 301a) does not return to the radiator 302 (radiator 302a), these antennas have a feature that frequency characteristics are good over a wide band.

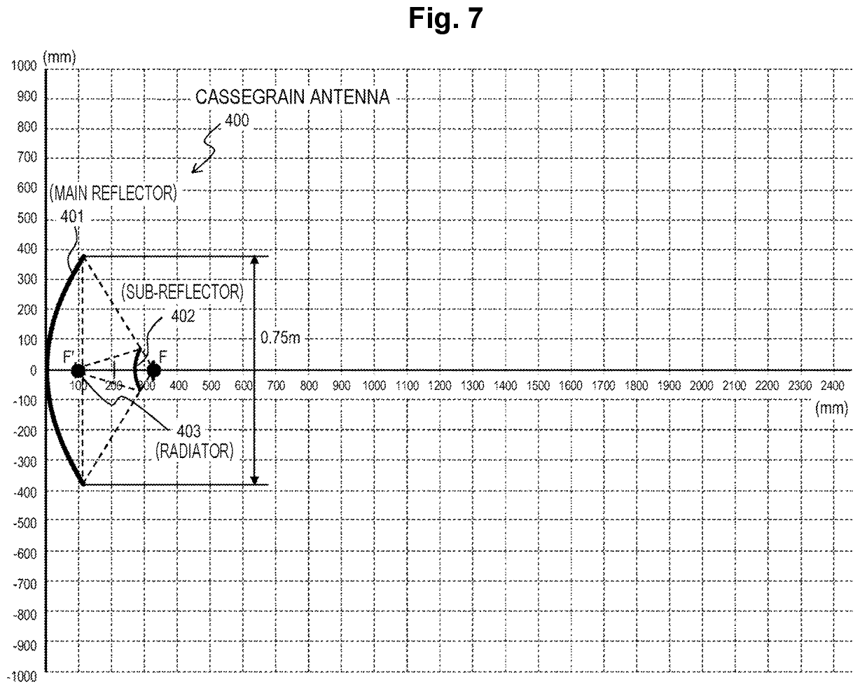

FIG. 7 illustrates an example of a Cassegrain antenna 400 of a standard size. In FIG. 7, the vertical axis represents the antenna aperture direction (mm), and the horizontal axis represents the radio wave radiation direction (mm).

The Cassegrain antenna 400 illustrated in FIG. 7 includes a main reflector 401, a sub-reflector 402, and a radiator 403. The aperture of the main reflector 401 is 0.75 m. The main reflector 401 forms a paraboloid of revolution, and the sub-reflector 402 forms a hyperboloid of revolution. The radiator 403 is arranged at the position of a focal point F′ of the sub-reflector 402. The focal point F′ corresponds to a feeding point, and a radio wave is radiated from the radiator 403 at a radiation angle corresponding to the entire surface of the hyperboloid of revolution of the sub-reflector 402. The radio wave radiated from the radiator 403 is reflected by the hyperboloid of revolution of the sub-reflector 402 and spreads so as to hit the entire surface of the paraboloid of revolution of the main reflector 401, and the radio wave reflected by the main reflector 401 is transmitted in the horizontal direction (communication direction) of the paper surface. Note that, at the time of reception, a radio wave arriving from the horizontal direction (communication direction) is reflected by the main reflector 401 and the sub-reflector 402, and is received by a receiver arranged at the position of the focal point F′.

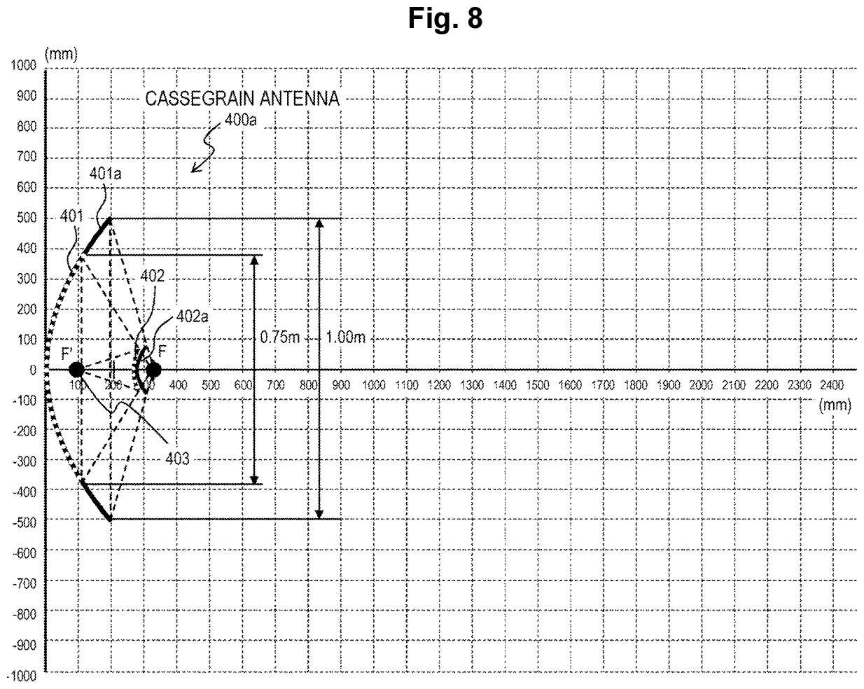

FIG. 8 illustrates an implementation example of a Cassegrain antenna 400a having an aperture larger than that of the Cassegrain antenna 400 of FIG. 7. In FIG. 8, the vertical axis represents the antenna aperture direction (mm), and the horizontal axis represents the radio wave radiation direction (mm).

The Cassegrain antenna 400a can increase the antenna gain without changing the radiation angle of the radiator 403 of the Cassegrain antenna 400 of FIG. 7. That is, the radiator 403 does not need to be replaced, and the Cassegrain antenna 400a can increase the antenna gain by increasing the area of the antenna by expansion of the main reflector 401 and replacing the sub-reflector 402 with a sub-reflector 402a without changing the position of the radiator 403 of the Cassegrain antenna 400 of FIG. 7.

The Cassegrain antenna 400a illustrated in FIG. 8 includes a main reflector 401a, the sub-reflector 402a, and the radiator 403. The aperture of the main reflector 401a is 1.00 m. The main reflector 401a forms a paraboloid of revolution, and the sub-reflector 402a forms a hyperboloid of revolution. The radiator 403 is arranged at the position of a focal point F′ of the sub-reflector 402a. Here, the position of the focal point F′ is the same as in the case of the Cassegrain antenna 400 of FIG. 7. The focal point F′ corresponds to a feeding point, and a radio wave is radiated from the radiator 403 at a radiation angle corresponding to the entire surface of the hyperboloid of revolution of the sub-reflector 402a. The radio wave radiated from the radiator 403 is reflected by the hyperboloid of revolution of the sub-reflector 402a and spreads so as to hit the entire surface of the paraboloid of revolution of the main reflector 401a, and the radio wave reflected by the main reflector 401a is transmitted in the horizontal direction (communication direction) of the paper surface. Note that, at the time of reception, the operation is reversed.

Here, the sub-reflector 402a has a reflection angle different from that of the sub-reflector 402, and reflects the radio wave radiated from the radiator 403 at an angle wider than that of the sub-reflector 402 such that the radio wave spreads over the entire surface of the main reflector 401a.

As described above, the Cassegrain antenna 400a illustrated in FIG. 8 can increase the antenna gain without replacing the radiator 403 of the Cassegrain antenna 400 having the aperture of 0.75 m illustrated in FIG. 7. That is, the Cassegrain antenna 400 having the aperture of 0.75 m can be used as the Cassegrain antenna 400a having the aperture of 1.00 m by increasing the area of the antenna by the expansion of the main reflector 401 of the Cassegrain antenna 400 and replacing the sub-reflector 402.

Note that a portion indicated by a dotted line, which is overlapped with the main reflector 401a, corresponds to the main reflector 401 of FIG. 7, and a portion indicated by a solid line corresponds to the expansion panel attached to the periphery or a part of the main reflector 401, which is described later. In addition, the Cassegrain antenna 400a has, for example, an attaching and detaching mechanism (corresponding to a third adjustment unit) that can easily replace the sub-reflector 402 with the sub-reflector 402a. The attaching and detaching mechanism may be any mechanism used in a general machine, as in the case of the radiator 202b described above.

Here, since each of the Cassegrain antenna 400 and the Cassegrain antenna 400a described with reference to FIGS. 7 and 8 is a normal center feed type antenna, the radio wave path is blocked by the radiator 403 (radiator 403a) and its feed line, which deteriorates radiation characteristics such as side lobe characteristics.

However, a double reflector antenna using a plurality of reflectors has a smaller cross-polarized wave component generated by the reflection mirror system than a parabolic antenna having the same aperture, a radiator having a large opening can be used, and thus such a double reflector antenna has a feature that a low cross-polarized wave and a wide band can be realized.

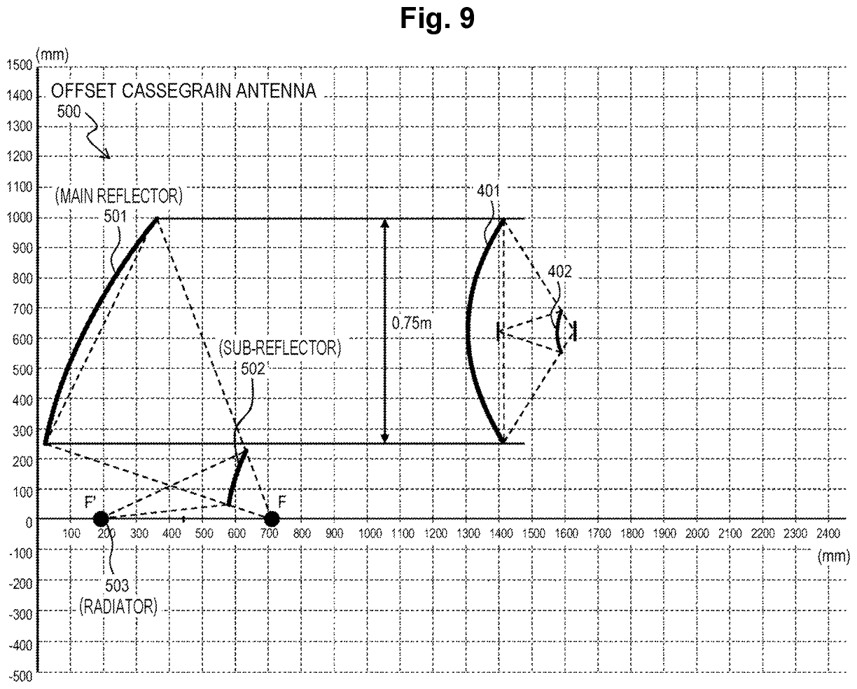

FIG. 9 illustrates an example of an offset Cassegrain antenna 500 of a standard size. In FIG. 9, the vertical axis represents the antenna aperture direction (mm), and the horizontal axis represents the radio wave radiation direction (mm).

The offset Cassegrain antenna 500 illustrated in FIG. 9 includes a main reflector 501, a sub-reflector 502, and a radiator 503. The offset Cassegrain antenna 500 has the same aperture as the Cassegrain antenna 400 having the aperture of 0.75 m. The main reflector 501 forms a paraboloid of revolution, and the sub-reflector 502 forms a hyperboloid of revolution. The radiator 503 is arranged at the position of a focal point F′ of the sub-reflector 502. The focal point F′ corresponds to a feeding point, and a radio wave is radiated from the radiator 503 at a radiation angle corresponding to the entire surface of the hyperboloid of revolution of the sub-reflector 502. The radio wave radiated from the radiator 503 is reflected by the hyperboloid of revolution of the sub-reflector 502 and spreads so as to hit the entire surface of the paraboloid of revolution of the main reflector 501, and the radio wave reflected by the main reflector 501 is transmitted in the horizontal direction (communication direction) of the paper surface. Note that, at the time of reception, the operation is reversed.

In this manner, the main reflector 501 of the offset Cassegrain antenna 500 functions as a reflector antenna having an aperture of 0.75 m, similarly to the main reflector 401 of the Cassegrain antenna 400.

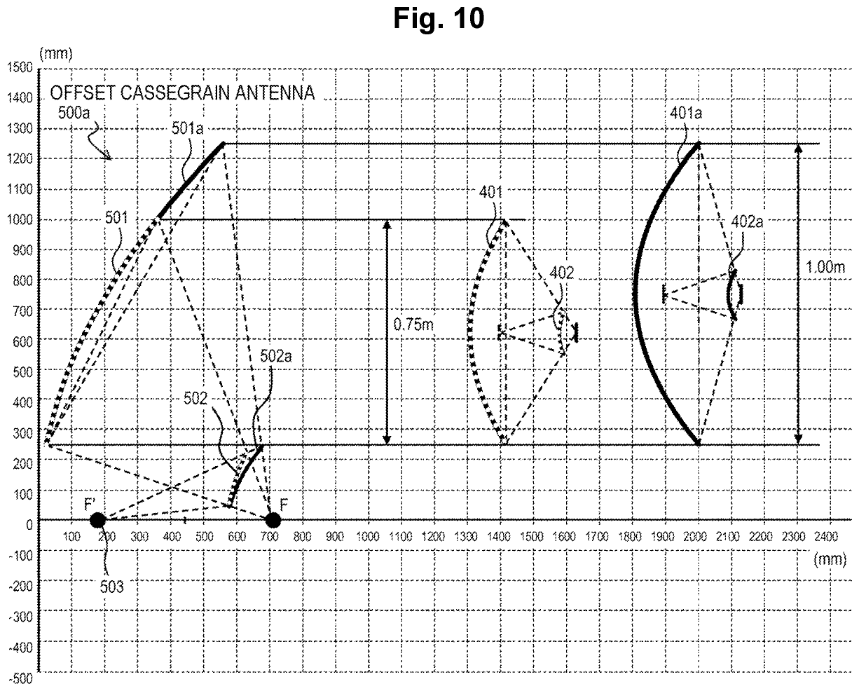

FIG. 10 illustrates an example of an offset Cassegrain antenna 500a having an aperture larger than that of the offset Cassegrain antenna 500 of FIG. 9. In FIG. 10, the vertical axis represents the antenna aperture direction (mm), and the horizontal axis represents the radio wave radiation direction (mm).

The offset Cassegrain antenna 500a can increase the antenna gain by increasing the area of the antenna by expansion of the main reflector 501 and replacing the sub-reflector 502 without changing the position and radiation angle of the radiator 503 of the offset Cassegrain antenna 500 of FIG. 9. That is, the radiator 503 does not need to be replaced.

The offset Cassegrain antenna 500a illustrated in FIG. 10 includes a main reflector 501a, a sub-reflector 502a, and the radiator 503. The aperture of the main reflector 501a is 1.00 m. The main reflector 501a forms a paraboloid of revolution, and the sub-reflector 502a forms a hyperboloid of revolution. The radiator 503 is disposed at the position of the focal point F′ of the sub-reflector 502 and the sub-reflector 502a. Here, the position of the focal point F′ is the same as in the case of the offset Cassegrain antenna 500 of FIG. 9. The focal point F′ corresponds to a feeding point, and a radio wave is radiated from the radiator 503 at a radiation angle corresponding to the entire surface of the hyperboloid of revolution of the sub-reflector 502a. The radio wave radiated from the radiator 503 is reflected by the hyperboloid of revolution of the sub-reflector 502a and spreads so as to hit the entire surface of the paraboloid of revolution of the main reflector 501a, and the radio wave reflected by the main reflector 501a is transmitted in the horizontal direction (communication direction) of the paper surface. Note that, at the time of reception, the operation is reversed.

Here, the sub-reflector 502a has a reflection angle different from that of the sub-reflector 502, and reflects the radio wave radiated from the radiator 503 at an angle wider than that of the sub-reflector 502 such that the radio wave spreads over the entire surface of the main reflector 501a.

As described above, the offset Cassegrain antenna 500a illustrated in FIG. 10 can increase the antenna gain without changing the radiator 503 of the offset Cassegrain antenna 500 having the aperture of 0.75 m illustrated in FIG. 9. That is, the offset Cassegrain antenna 500 having the aperture of 0.75 m can be used as the offset Cassegrain antenna 500a having the aperture of 1.00 m by increasing the area of the antenna by the expansion of the main reflector 501 and replacing the sub-reflector 502.

Note that a portion indicated by a dotted line, which is overlapped with the main reflector 501a, corresponds to the main reflector 501 of FIG. 9, and a portion indicated by a solid line corresponds to the expansion panel attached to the periphery or a part of the main reflector 501, which is described later. Furthermore, in the example of FIG. 10, the main reflector 501 is expanded unidirectionally, but may be expanded bidirectionally or expanded to the entire periphery. Furthermore, the offset Cassegrain antenna 500a has, for example, an attaching and detaching mechanism (corresponding to the third adjustment unit) that can easily replace the sub-reflector 502 with the sub-reflector 502a. The attaching and detaching mechanism may be any mechanism used in a general machine, as in the case of the sub-reflector 402a described above.

Here, in each of the offset Cassegrain antenna 500 and the offset Cassegrain antenna 500a described with reference to FIGS. 9 and 10, the sub-reflector 502 (502a) and the radiator 503 (503a) are not within the radio wave radiation path of the main reflector 501 (501a). Therefore, there is no performance degradation due to blocking, and these antennas are effective as low side lobe antennas, and have a feature that parameters of the two reflectors of the main reflector 501 (501a) and the sub-reflector 502 (502a) are appropriately selected, so that the generation of the cross-polarized wave component can be eliminated.

Note that, the offset Cassegrain antenna 500a is more efficient than the center feed type Cassegrain antenna 400a and is smaller than other antennas (for example, an offset Gregorian antenna 700a to be described later). Therefore, the offset Cassegrain antenna 500a has the most feasible structure in the embodiments.

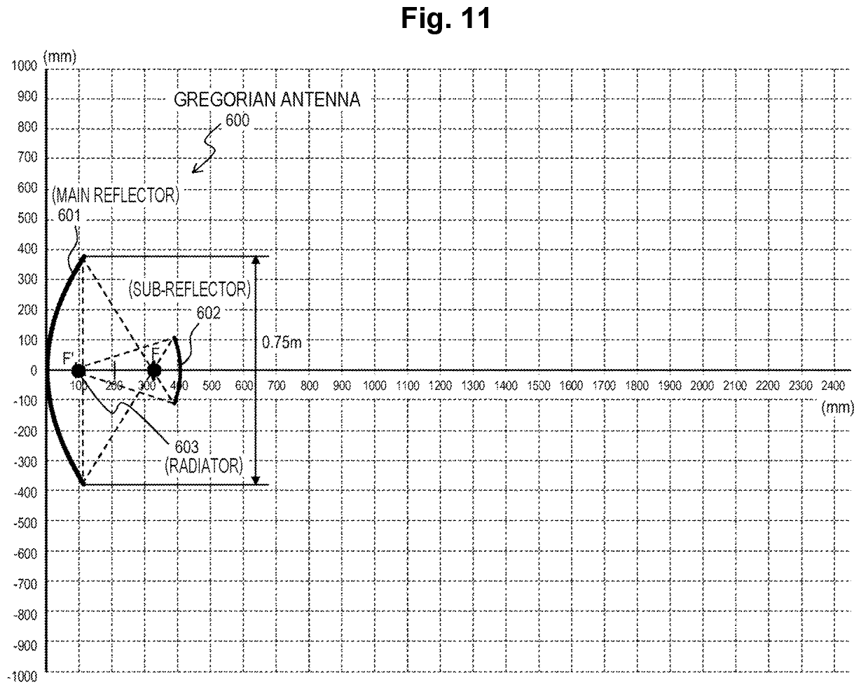

FIG. 11 illustrates an example of a Gregorian antenna 600 of standard size. In FIG. 11, the vertical axis represents the antenna aperture direction (mm), and the horizontal axis represents the radio wave radiation direction (mm).

The Gregorian antenna 600 illustrated in FIG. 11 includes a main reflector 601, a sub-reflector 602, and a radiator 603. The aperture of the main reflector 601 is 0.75 m. The main reflector 601 forms a paraboloid of revolution, and the sub-reflector 602 forms an ellipsoid of revolution. The radiator 603 is arranged at the position of a focal point F′ of the sub-reflector 602. The focal point F′ corresponds to a feeding point, and a radio wave is radiated from the radiator 603 at a radiation angle corresponding to the entire surface of the ellipsoid of revolution of the sub-reflector 602. The radio wave emitted from the radiator 603 is reflected by the ellipsoid of revolution of the sub-reflector 602 and spreads so as to hit the entire surface of the paraboloid of revolution of the main reflector 601 through a shared focal point F between the main reflector 601 and the sub-reflector 602, and the radio wave reflected by the main reflector 601 is transmitted in the horizontal direction (communication direction) of the paper surface. Note that, at the time of reception, a radio wave arriving from the horizontal direction (communication direction) is reflected by the main reflector 601 and the sub-reflector 602, and is received by a receiver arranged at the position of the focal point F′.

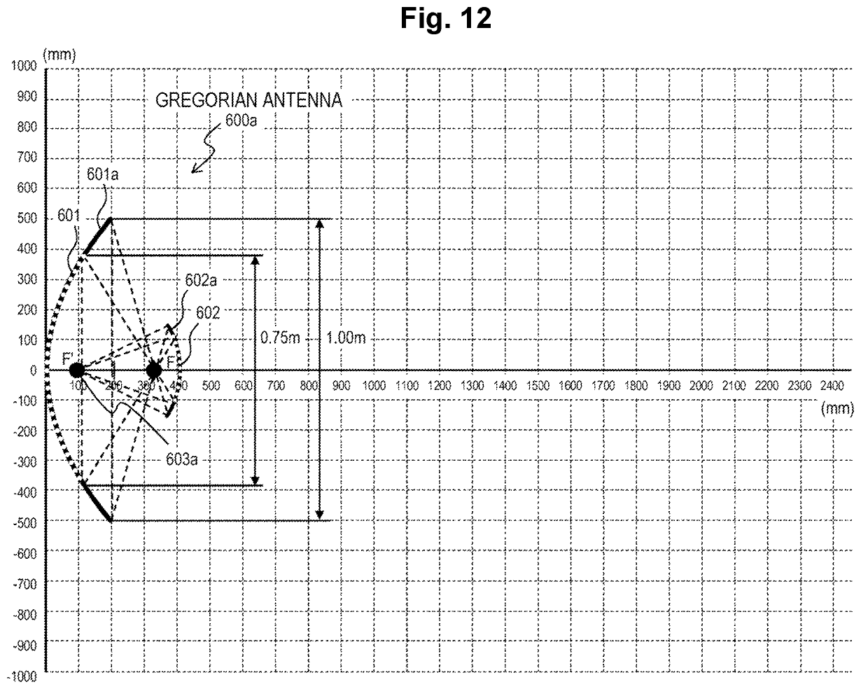

FIG. 12 illustrates an implementation example of a Gregorian antenna 600a having an aperture larger than that of the Gregorian antenna 600 of FIG. 11. In FIG. 12, the vertical axis represents the antenna aperture direction (mm), and the horizontal axis represents the radio wave radiation direction (mm).

The Gregorian antenna 600a can increase the antenna gain without changing the position of the radiator 603 of the Gregorian antenna 600 of FIG. 11, but it is necessary to replace the radiator 603 because the radiation angle is different. That is, the Gregorian antenna 600 having the aperture of 0.75 m can be used as the Gregorian antenna 600a having an aperture of 1.00 m by increasing the area of the antenna by expansion of the main reflector 601, replacing the sub-reflector 602, and replacing the radiator 603, so that the antenna gain can be increased.

The Gregorian antenna 600a illustrated in FIG. 12 includes a main reflector 601a, a sub-reflector 602a, and a radiator 603a. The aperture of the main reflector 601a is 1.00 m. The main reflector 601a forms a paraboloid of revolution, and the sub-reflector 602a forms an ellipsoid of revolution. The radiator 603a is arranged at the position of a focal point F′ of the sub-reflector 602a. Here, the position of the focal point F′ is the same as in the case of the Gregorian antenna 600 of FIG. 11, but the radiation angles of the radiator 603 and the radiator 603a are different. The focal point F′ corresponds to a feeding point, and a radio wave is radiated from the radiator 603 at a radiation angle corresponding to the entire surface of the ellipsoid of revolution of the sub-reflector 602a. The radio wave radiated from the radiator 603a is reflected by the ellipsoid of revolution of the sub-reflector 602a and spreads so as to hit the entire surface of the paraboloid of revolution of the main reflector 601a, and the radio wave reflected by the main reflector 601a is transmitted in the horizontal direction (communication direction) of the paper surface. Note that, at the time of reception, the operation is reversed.

As described above, the Gregorian antenna 600a illustrated in FIG. 12 can increase the antenna gain without changing the position of the radiator 603 of the Gregorian antenna 600 having the aperture of 0.75 m illustrated in FIG. 11.

Note that a portion indicated by a dotted line, which is overlapped with the main reflector 601a, corresponds to the main reflector 601 of FIG. 11, and a portion indicated by a solid line corresponds to the expansion panel attached to the periphery or a part of the main reflector 601, which is described later. Similarly, in a case where the sub-reflector 602 is expanded, a portion indicated by a dotted line, which is overlapped with the sub-reflector 602a, corresponds to the sub-reflector 602 of FIG. 11, and a portion indicated by a solid line corresponds to an expansion panel (sub-expansion panel) attached to the periphery or a part of the sub-reflector 602, which is described later. Alternatively, the entire sub-reflector 602 may be replaced with the sub-reflector 602a instead of expanding the sub-reflector 602 with the expansion panel. In this case, the Gregorian antenna 600a has, for example, an attaching and detaching mechanism (corresponding to the third adjustment unit) that can easily replace the sub-reflector 602 with the sub-reflector 602a. Similarly, the Gregorian antenna 600a has, for example, an attaching and detaching mechanism (corresponding to the second adjustment unit) that can easily replace the radiator 603 with the radiator 603a. These attaching and detaching mechanisms may be any mechanisms used in general machines as in the case of the sub-reflector 402a and the radiator 202b described above.

Here, since each of the Gregorian antenna 600 and the Gregorian antenna 600a described with reference to FIGS. 11 and 12 is a normal center feed type antenna, the radio wave path is blocked by the radiator 603 (radiator 603a) and its feed line, which deteriorates radiation characteristics such as side lobe characteristics. However, a double reflector antenna using a plurality of reflectors has a smaller cross-polarized wave component generated by the reflection mirror system than a parabolic antenna having the same aperture, a radiator having a large opening can be used, and thus such a double reflector antenna has a feature that a low cross-polarized wave and a wide band can be realized.

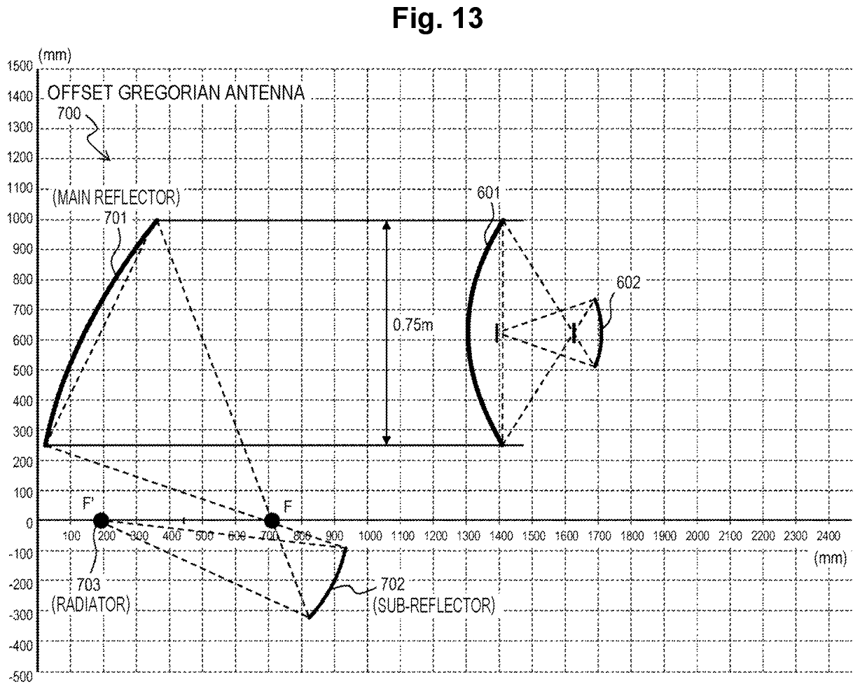

FIG. 13 illustrates an example of an offset Gregorian antenna 700 of standard size. In FIG. 13, the vertical axis represents the antenna aperture direction (mm), and the horizontal axis represents the radio wave radiation direction (mm).

The offset Gregorian antenna 700 illustrated in FIG. 13 includes a main reflector 701, a sub-reflector 702, and a radiator 703. The offset Gregorian antenna 700 has the same aperture as the Gregorian antenna 600 having the aperture of 0.75 m. The main reflector 701 forms a paraboloid of revolution, and the sub-reflector 702 forms an ellipsoid of revolution. The radiator 703 is arranged at the position of a focal point F′ of the sub-reflector 702. The focal point F′ corresponds to a feeding point, and a radio wave is radiated from the radiator 703 at a radiation angle corresponding to the entire surface of the ellipsoid of revolution of the sub-reflector 702. The radio wave radiated from the radiator 703 is reflected by the ellipsoid of revolution of the sub-reflector 702 and spreads so as to hit the entire surface of the paraboloid of revolution of the main reflector 701, and the radio wave reflected by the main reflector 701 is transmitted in the horizontal direction (communication direction) of the paper surface. Note that, at the time of reception, the operation is reversed.

As described above, the offset Gregorian antenna 700 functions as a reflector antenna having an aperture of 0.75 m, similarly to the Gregorian antenna 600.

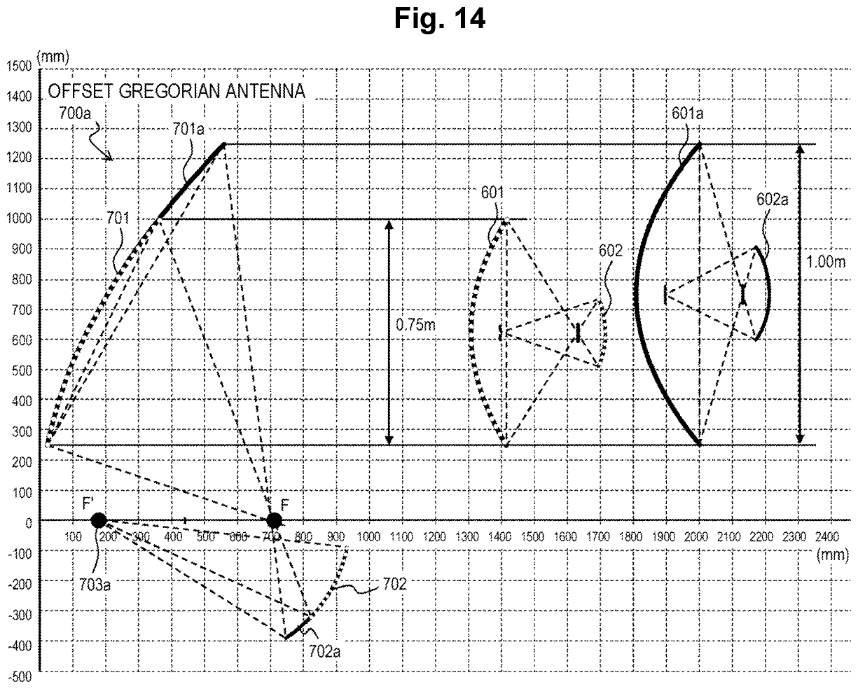

FIG. 14 illustrates an implementation example of the offset Gregorian antenna 700a having an aperture larger than that of the offset Gregorian antenna 700 of FIG. 13. In FIG. 14, the vertical axis represents the antenna aperture direction (mm), and the horizontal axis represents the radio wave radiation direction (mm).

The offset Gregorian antenna 700a can increase the antenna gain by increasing the area of the antenna by expansion of the main reflector 701 of the offset Gregorian antenna 700 of FIG. 13, expanding or replacing the sub-reflector 702, and changing the radiation angle, which involves replacement of the radiator 703. That is, the offset Gregorian antenna 700 having the aperture of 0.75 m can be used as the offset Gregorian antenna 700a having an aperture of 1.00 m.

The offset Gregorian antenna 700a illustrated in FIG. 14 includes a main reflector 701a, a sub-reflector 702a, and a radiator 703a. The aperture of the main reflector 701a is 1.00 m. The main reflector 701a forms a paraboloid of revolution, and the sub-reflector 702a forms an ellipsoid of revolution. The radiator 703a is arranged at the position of a focal point F′ of the sub-reflector 702a. Here, the position of the focal point F′ is the same as in the case of the offset Gregorian antenna 700 of FIG. 13. The focal point F′ corresponds to a feeding point, and a radio wave is radiated from the radiator 703a at a radiation angle corresponding to the entire surface of the ellipsoid of revolution of the sub-reflector 702a. The radio wave radiated from the radiator 703a is reflected by the ellipsoid of revolution of the sub-reflector 702a and spreads so as to hit the entire surface of the paraboloid of revolution of the main reflector 701a, and the radio wave reflected by the main reflector 701a is transmitted in the horizontal direction (communication direction) of the paper surface. Note that, at the time of reception, the operation is reversed.

Here, as for the sub-reflector 702a of the offset Gregorian antenna 700a described with reference to FIG. 14, the expansion panel (in this case, the sub-expansion panel) having a configuration similar to the expansion panel used in the main reflector 701a is attached to the sub-reflector 702, so that the sub-reflector 702 can be used as the sub-reflector 702a. Note that, since the sub-reflector 702a is smaller than the main reflector 701a and does not significantly affect the transportability, the entire sub-reflector 702 may be replaced with the sub-reflector 702a. Alternatively, the sub-reflector 702a may be mounted as a standard sub-reflector on the portable station device 104. In this case, even if the portable station device 104 is operated by the standard main reflector 701, only a dotted line portion of the sub-reflector 702a, which corresponds to the sub-reflector 702, is used, and thus the antenna performance is not affected because the antenna is an offset type antenna in which the sub-reflector 702a is not on the radio wave radiation path.

As described above, the offset Gregorian antenna 700a illustrated in FIG. 14 can increase the antenna gain by increasing the area of the antenna by the expansion of the main reflector 701, expanding or replacing the sub-reflector 702, and changing the radiation angle, which involves the replacement of the radiator 703, without changing the position of the radiator 703 of the offset Gregorian antenna 700 having the aperture of 0.75 m illustrated in FIG. 13.

Note that a portion indicated by a dotted line, which is overlapped with the main reflector 701a, corresponds to the main reflector 701 of FIG. 13, and a portion indicated by a solid line corresponds to the expansion panel attached to the periphery or a part of the main reflector 701, which is described later. Note that, in the example of FIG. 14, the main reflector 701 is expanded unidirectionally, but may be expanded bidirectionally or expanded to the entire periphery.

Similarly, in a case where the sub-reflector 702 is expanded, a portion indicated by the dotted line, which is overlapped with the sub-reflector 702a, corresponds to the sub-reflector 702 of FIG. 13, and a portion indicated by a solid line corresponds to the expansion panel (sub-expansion panel) attached to the periphery or a part of the sub-reflector 702, which is described later. Alternatively, the sub-reflector 702 may be replaced with the sub-reflector 702a without being expanded by the expansion panel. In this case, the offset Gregorian antenna 700a has, for example, an attaching and detaching mechanism (corresponding to the third adjustment unit) that can easily replace the sub-reflector 702 with the sub-reflector 702a. Similarly, the offset Gregorian antenna 700a has, for example, an attaching and detaching mechanism (corresponding to the second adjustment unit) that can easily replace the radiator 703 with the radiator 703a. These attaching and detaching mechanisms may be any mechanisms used in general machines as in the case of the sub-reflector 402a and the radiator 202b described above. Alternatively, in a case where the radiation angle of the radiator 703a can be implemented by a mechanism or a member that changes the radiation angle of the radiator 703, mounting the sub-reflector 702a as a standard sub-reflector as described above makes it possible to increase the antenna gain only by expanding the main reflector 701.

Here, as in the other offset type reflector antennas, in each of the offset Gregorian antenna 700 and the offset Gregorian antenna 700a described with reference to FIGS. 13 and 14, the sub-reflector 702 (702a) and the radiator 703 (703a) are not within the radio wave radiation path of the main reflector 701 (701a). Therefore, there is no performance degradation due to blocking, and these antennas are effective as low side lobe antennas, and have a feature that parameters of the two reflectors of the main reflector 701 (701a) and the sub-reflector 702 (702a) are appropriately selected, so that the generation of the cross-polarized wave component can be eliminated. However, when compared to the offset Cassegrain antenna 500 (500a) having the same aperture described with reference to FIGS. 9 and 10, the offset Gregorian antenna 700 (700a) includes the sub-reflector 702 (702a) outside the focal point F, and thus, the size of the entire antenna is larger.

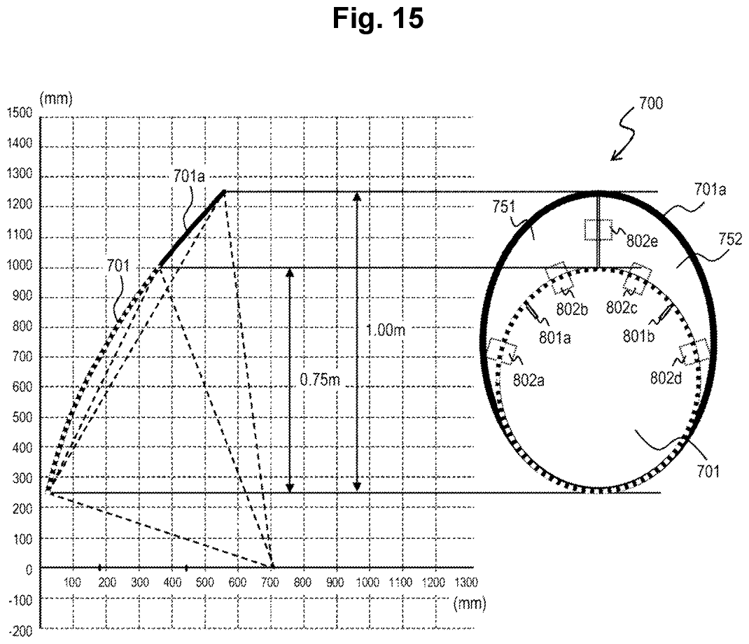

FIG. 15 illustrates a specific example of the main reflector 701a of the offset Gregorian antenna 700a described with reference to FIG. 14. Note that, in FIG. 15, the main reflector 701a of the offset Gregorian antenna 700a will be described, but it is possible to similarly implement the main reflector 301a of the offset parabolic antenna 300a of FIG. 6 and the main reflector 501a of the offset Cassegrain antenna 500a of FIG. 10, each of which is a similar main reflector.

In addition, even the main reflector 201a of the parabolic antenna 200a of FIG. 3, the main reflector 201b of the parabolic antenna 200b of FIG. 4, the main reflector 401a of the Cassegrain antenna 400a of FIG. 8, and the main reflector 601a of the Gregorian antenna 600a of FIG. 12, each of which is a main reflector included in an antenna that is not an offset type antenna, differ only in the mounting location, position, shape, size, and the like of the expansion panel, and can be implemented similarly to the specific example to be described later.

In FIG. 15, the main reflector 701a of the offset Gregorian antenna 700a includes the main reflector 701 of the offset Gregorian antenna 700 mounted as a standard antenna on the portable station device 104, an expansion panel 751, and an expansion panel 752.

A mounting position of the expansion panel 751 is fixed by a guide 801a, and the expansion panel 751 is fixed to the main reflector 701 by a fixing metal fitting 802a and a fixing metal fitting 802b.

A mounting position of the expansion panel 752 is fixed by a guide 801b, and the expansion panel 752 is fixed to the main reflector 701 by a fixing metal fitting 802c and a fixing metal fitting 802d.

Furthermore, the expansion panel 751 and the expansion panel 752 are fixed to each other by a fixing metal fitting 802e. Note that, similarly to the guide 801a and the like, a guide may be provided between the expansion panel 751 and the expansion panel 752.

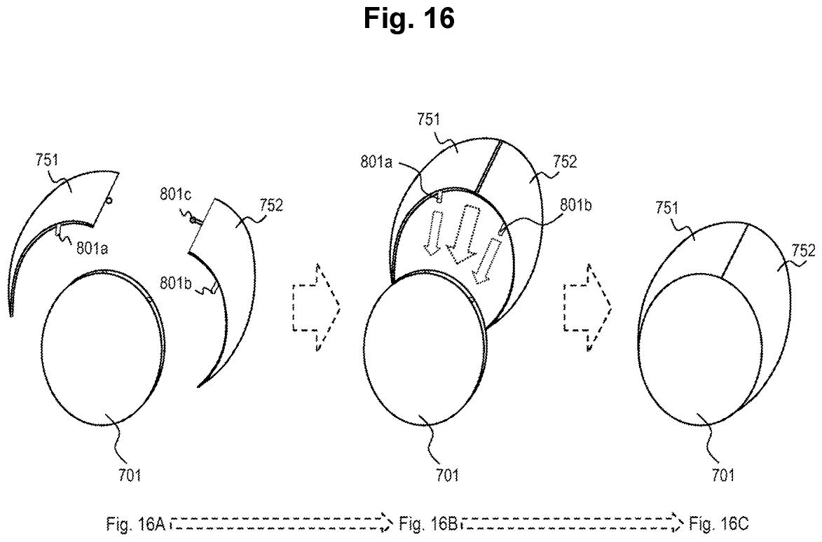

FIG. 16 illustrates an example of a procedure for expanding the main reflector 701 of the offset Gregorian antenna 700 mounted as a standard antenna on the portable station device 104 described with reference to FIG. 15. Note that, in the case of the main reflector 201a of the parabolic antenna 200a of FIG. 3, the main reflector 201b of the parabolic antenna 200b of FIG. 4, the main reflector 401a of the Cassegrain antenna 400a of FIG. 8, and the main reflector 601a of the Gregorian antenna 600a of FIG. 12, each of which is a main reflector included in an antenna that is not an offset type antenna, the expansion panel may be attached to the periphery of each of the main reflectors, or the expansion panel may be attached to a part (for example, both sides or the like) of each of the main reflectors according to radiation characteristics of radio waves.

In FIG. 16, the main reflector 701, the expansion panel 751, and the expansion panel 752 are assembled from a state FIG. 16A to a state FIG. 16C while their positions are fixed with the guides 801a, 801b, and 801c. Finally, as described with reference to FIG. 15, the main reflector 701, the expansion panel 751, and the expansion panel 752 are fixed to each other by the fixing metal fittings 802a, 802b, 802c, 802d, and 802e.

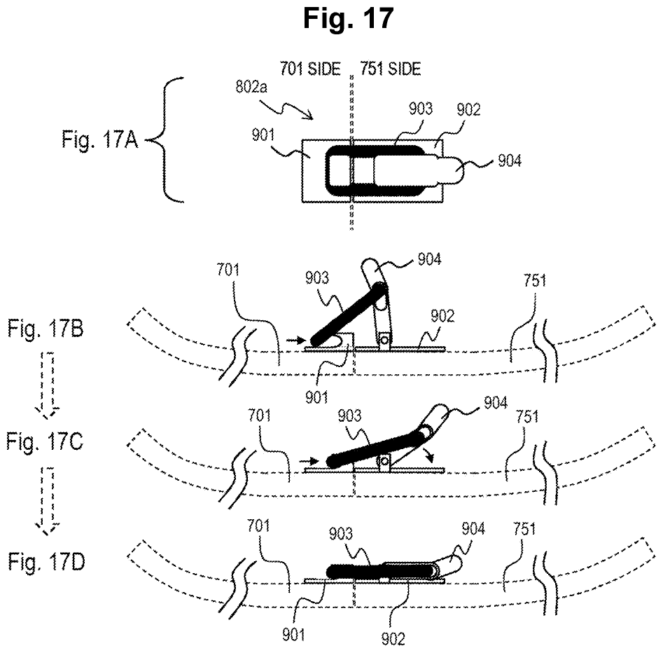

FIG. 17 illustrates an example of the fixing metal fitting 802a. Note that the other fixing metal fittings 802b, 802c, 802d, and 802e are configured similarly to the fixing metal fitting 802a. Here, the fixing metal fitting 802a in FIG. 17 is an example, and the main reflector 701, the expansion panel 751, and the expansion panel 752 may be fixed by another member having a similar function.

In FIG. 17A, the fixing metal fitting 802a is a metal fitting for fixing the side of the main reflector 701 and the side of the expansion panel 751. The fixing metal fitting 802a includes a base 901 fixed to the main reflector 701, a base 902 fixed to the expansion panel 751, a square ring 903 hooked on a recess of the base 901, and a lever 904 rotatably attached to the base 902. The square ring 903 is rotatably attached to the lever 904 with an appropriate amount of play, and a spring that pulls the square ring 903 toward the upper portion of the lever 904 is built in the lever 904.

In FIG. 17B, the square ring 903 is hooked on the recess of the base 901 on the side of the main reflector 701.

In FIG. 17C, the lever 904 is tilted toward the base 902 while pulling the square ring 903 toward the expansion panel 751.

In FIG. 17D, the square ring 903 fixes the base 901 on the side of the main reflector 701 and the base 902 on the side of the expansion panel 751 by the spring built in the lever 904.

In this manner, as described with reference to FIGS. 15 and 16, the main reflector 701 of the offset Gregorian antenna 700 having the aperture of 0.75 m mounted as a standard antenna on the portable station device 104 is expanded, so that the main reflector 701 can be used as the main reflector 701a of the offset Gregorian antenna 700a having the aperture of 1.00 m.

Here, as for the sub-reflector 702 of the offset Gregorian antenna 700a described with reference to FIG. 14, the expansion panel (in the case of the sub-reflector, the expansion panel may be referred to as the sub-expansion panel) having a configuration similar to the expansion panel used in the main reflector 701 is attached to the sub-reflector 702, so that the sub-reflector 702 can be used as the sub-reflector 702a. Note that, since the sub-reflector 702a is smaller than the main reflector 701a and does not significantly affect the transportability, the entire sub-reflector 702 may be replaced with the sub-reflector 702a. Alternatively, the sub-reflector 702a may be mounted as a standard sub-reflector on the portable station device 104. In this case, in a case where the portable station device 104 is operated with the standard main reflector 701, only the dotted line portion of the sub-reflector 702a, which corresponds to the sub-reflector 702, is used, and thus the antenna performance is not affected because the antenna is an offset type antenna.

As described above, in a reflector antenna and an antenna aperture expansion method according to the present invention, an aperture expansion panel is attached to a main reflector of a standard-aperture reflector antenna, and one or both of a radiator and a sub-reflector are changed, so that it is possible to implement a large-aperture antenna having excellent transportability and operability without preparing another antenna having a large aperture and replacing the standard-aperture antenna.

In particular, in the reflector antenna and the antenna aperture expansion method according to the present invention, it is only required to carry a portable station device of a standard antenna, an optional expansion panel, and a replacement part of at least one of a radiator and a sub-reflector that can be more easily transported than a main reflector. As a result, it is possible to secure the communication quality without impairing the transportability and the operability in an edge area of a service area where a gain is insufficient with an antenna of a standard size and the communication quality is insufficient.

### REFERENCE SIGNS LIST

100 Satellite communication system
101 Communication satellite
102 Base station device
103 Terminal station device (fixed station device)
104 Terminal station device (portable station device)
105 Network
200, 200a, 200b Parabolic antenna
201, 201a, 201b, 301, 301a, 401, 401a, 501, 501a, 601, 601a, 701, 701a Main reflector
202, 202a, 202b, 302, 302a, 403, 503, 603, 603a, 703, 703a Radiator
300, 300a Offset parabolic antenna
400, 400a Cassegrain antenna
402, 402a, 502, 502a, 602, 602a, 702, 702a Sub-reflector
500, 500a Offset Cassegrain antenna
600, 600a Gregorian antenna
700, 700a Offset Gregorian antenna
751, 752 Expansion panel
801a, 801b, 801c Guide
802a, 802b, 802c, 802d, 802e Fixing metal fitting
901, 902 Base
903 Square ring
904 Lever

1. A reflector antenna comprising:
a radiator that radiates a radio wave;
a main reflector that reflects the radio wave radiated from the radiator in a communication direction;
an expansion panel that is attached to at least a part of the main reflector to increase an area of the main reflector; and
a first adjustment unit that changes a position of the radiator, or a second adjustment unit that replaces the radiator with a radiator having a different radiation angle.

2. The reflector antenna according to claim 1, further comprising:
a sub-reflector between the radiator and the main reflector; and
a third adjustment unit that replaces the sub-reflector with a sub-reflector having a different reflection angle, or a sub-expansion panel that is attached to at least a part of the sub-reflector to expand the sub-reflector.

3. The reflector antenna according to claim 1, wherein the reflector antenna is a parabolic antenna or an offset parabolic antenna.

4. The reflector antenna according to claim 2, wherein the reflector antenna is any one of a Cassegrain antenna, an offset Cassegrain antenna, a Gregorian antenna, and an offset Gregorian antenna.

5. An antenna aperture expansion method for a reflector antenna including a radiator that radiates a radio wave and a main reflector that reflects the radio wave radiated from the radiator in a communication direction, the antenna aperture expansion method comprising:
attaching an expansion panel to at least a part of the main reflector to increase an area of the main reflector; and
changing a position of the radiator or replacing the radiator with a radiator having a different radiation angle.

6. The antenna aperture expansion method according to claim 5, wherein
in a case where a sub-reflector is further provided between the radiator and the main reflector,
the sub-reflector is replaced with a sub-reflector having a different reflection angle, or a sub-expansion panel is attached to at least a part of the sub-reflector.
